(19) United States
(12) Patent Application Publication
(10) Pub. No.: US 2024/0020722 A1
(43) Pub. Date: Jan. 18, 2024

(54) SYSTEMS AND METHODS FOR MANAGING INCENTIVES

(71) Applicant: Palantir Technologies Inc., Denver, CO (US)

(72) Inventors: Ashkhen Martirosyan, San Diego, CA (US); Andrew St. Pierre, Sunnyvale, CA (US); Emily Greene, Brooklyn, NY (US); Frances Batton, San Diego, CA (US); Madeline Parker, Evergreen, CO (US); Tinlok Pang, New York, NY (US)

(21) Appl. No.: 18/174,303

(22) Filed: Feb. 24, 2023

Related U.S. Application Data
(60) Provisional application No. 63/318,306, filed on Mar. 9, 2022.

(51) Int. Cl. G06Q 30/0207

(52) U.S. Cl. CPC G06Q 30/0236

(57) ABSTRACT

An incentive management system can receive one or more data items associated with a member of an organization; categorize said one or more data items; and store, according to the categorization, the one or more data items in at least one of a plurality of data sets. The system can access the plurality of data sets to retrieve relevant data to automatically calculate an incentive based at least in part on the retrieved data.

### TECHNICAL FIELD

The present disclosure relates to systems and techniques for data integration, analysis, and visualization. More specifically, the present disclosure relates to an incentive management system that may be configured to calculate incentives of members of an organization and generate interactive graphical user interfaces to facilitate review of, and interaction with, the incentives.

### BACKGROUND

Existing incentive management tools lack automated processes for handling calculation and execution of complex incentive structures. Existing tools offer only limited or no administrator oversight which inhibits the administrators' ability to manage member incentives. For example, administrators are not able to quickly review and approve incentives prior to their execution and distribution.

Additionally, existing tools lack capability to integrate with existing systems to handle complex incentive structures. For example, existing tools don't account for nuanced contract terms such as termination-for-convenience terms and non-incentive eligible portions of contracts.

### SUMMARY

Information relating to members is provided to the system during an onboarding process, and automatic updates to multiple related data sets are performed. The information may be categorized and stored in an optimized data schema comprising various data sets, which may all be updated and are separately accessible by other processes. The various data sets may include information relating to activities performed by the member, objectives assigned to the member, previous incentives received by the member, terms of an agreement between the member and an organization, and the like. Separating and storing the entered information according to the data schema allows for handling complex and nuanced conditions when processing the information (e.g., to calculate incentives, to generate notifications, etc.) and also results in faster processing times by improving data access and retrieval from the specific data sets of the data schema.

Incentives are automatically calculated based on accessing relevant data in the data schema. A calculated incentive triggers any necessary reviews and approvals. The approval process can be pre-defined with required reviewing actions and personnel to act as reviewers. Reviewers are automatically notified (e.g., via email) when they need to take a reviewing action. Reviewers, which can include management personnel or other administrators, can view the calculated incentive, which may account for any advances already received by the member, and can approve, reject, or flag the incentive, or take other action as appropriate. The review and approval process can be stored in an audit log which can facilitate internal and/or external audit procedures as well as compliance validation.

Approved incentives are queued for execution according to generated execution data, such as from a time tracking or payroll system, so that the member receives the incentive according to an expected date.

In various embodiments, large amounts of data are automatically and dynamically calculated interactively in response to user inputs, and the calculated data is efficiently and compactly presented to a user by the system. Thus, in some embodiments, the user interfaces described herein are more efficient as compared to previous user interfaces in which data is not dynamically updated and compactly and efficiently presented to the user in response to interactive inputs.

Further, as described herein, the system may be configured and/or designed to generate user interface data useable for rendering the various interactive user interfaces described. The user interface data may be used by the system, and/or another computer system, device, and/or software program (for example, a browser program), to render the interactive user interfaces. The interactive user interfaces may be displayed on, for example, electronic displays (including, for example, touch-enabled displays).

Additionally, design of computer user interfaces that are useable and easily learned by humans is a non-trivial problem for software developers. The various embodiments of interactive and dynamic user interfaces of the present disclosure are the result of significant research, development, improvement, iteration, and testing. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interfaces described herein may provide an optimized display of time-varying report-related information and may enable a user to more quickly access, navigate, assess, and digest such information than previous systems.

Further, the interactive and dynamic user interfaces described herein are enabled by innovations in efficient interactions between the user interfaces and underlying systems and components. For example, disclosed herein are improved methods of receiving user inputs, translation and delivery of those inputs to various system components, automatic and dynamic execution of complex processes in response to the input delivery, automatic interaction among various components and processes of the system, and automatic and dynamic updating of the user interfaces. The interactions and presentation of data via the interactive user interfaces described herein may accordingly provide cognitive and ergonomic efficiencies and advantages over previous systems.

Various embodiments of the present disclosure provide improvements to various technologies and technological fields. For example, existing data storage and processing technology (including, e.g., in memory databases) is limited in various ways (e.g., manual data review is slow, costly, and less detailed; data is too voluminous; etc.), and various embodiments of the disclosure provide significant improvements over such technology. Additionally, various embodiments of the present disclosure are inextricably tied to computer technology. In particular, various embodiments rely on detection of user inputs via graphical user interfaces, calculation of updates to displayed electronic data based on those user inputs, automatic processing of related electronic data, and presentation of the updates to displayed images via interactive graphical user interfaces. Such features and others (e.g., processing and analysis of large amounts of electronic data) are intimately tied to, and enabled by, computer technology, and would not exist except for computer technology. For example, the interactions with displayed data described below in reference to various embodiments cannot reasonably be performed by humans alone, without the computer technology upon which they are implemented. Further, the implementation of the various embodiments of the present disclosure via computer technology enables many of the advantages described herein, including more efficient interaction with, and presentation of, various types of electronic data.

The present disclosure provides an incentive management computing system. The system can comprise: a computer readable storage medium having program instructions embodied therewith; and one or more processors configured to execute the program instructions. In some embodiments, the one or more processors can be configured to execute the program instructions to cause the computing system to: receive one or more data items associated with a member of an organization; categorize said one or more data items according to a categorization schema based at least on one or more data item properties associated with the data items; store the one or more data items in at least one of a plurality of data sets, wherein each data set of the plurality of data sets corresponds to one or more data item type and wherein the one or more data items are stored according to the categorization schema; generate, based on the received one or more data items, member profile data; store the member profile data in one of the plurality of data sets; access at least one of the plurality of data sets to retrieve the member profile data and at least one of the one or more data items; automatically calculate an incentive based at least in part on the member profile data and the retrieved one or more data items; in response to calculating the incentive, generate a review process indicating one or more reviewers; provide user interface information to each of the one or more reviewers, wherein the user interface information is configured to display an interactive user interface indicating the calculated incentive and includes options for selection of a reviewing action of a plurality of predefined reviewing actions; receive, from each of the one or more reviewers, an indication of a selected reviewing action; in response to determining that the selected reviewing action meets an incentive approval requirement, generate execution data for executing the incentive; and initiate execution of the incentive according to the execution data.

In some embodiments, the one or more processors can be further configured to execute the program instructions to cause the computing system to access, according to the categorization schema, less than all of the plurality of data sets to retrieve the member profile data and at least one of the one or more data items.

In some embodiments, the one or more processors can be further configured to execute the program instructions to cause the computing system to retrieve activity data relating to actions performed by the member; and automatically calculate the incentive based at least in part on the activity data.

In some embodiments, the member profile data can include objectives assigned to the member to be completed by the member.

In some embodiments, the calculated incentive can include a date for executing the incentive.

In some embodiments, the one or more processors can be further configured to execute the program instructions to cause the computing system to, in response to generating the member profile data, generate a request to send to the one or more reviewers to approve the member profile data.

In some embodiments, the member profile data can include an agreement between the member and the organization.

In some embodiments, the one or more processors can be further configured to execute the program instructions to cause the computing system to, in response to generating the review process, generate a notification to notify the one or more reviewers to review the calculated incentive.

In some embodiments, the plurality of predefined reviewing actions includes one or more of approving the incentive, rejecting the incentive, or flagging the incentive.

In some embodiments, the one or more processors can be further configured to execute the program instructions to cause the computing system to, in response to receiving the selected reviewing action from each of the one or more reviewers, store the selected reviewing action in an audit log. As discussed further below, audit logs may be configured to store information related to any activities associated with the system, such as other activities discussed herein.

In some embodiments, the one or more processors can be further configured to execute the program instructions to cause the computing system to receive from a reviewer of the one or more reviewers an indication of a selected update to the incentive; in response to receiving the selected update to the incentive, update the incentive according to the selected update; and store the selected update in an audit log.

In some embodiments, the one or more processors can be further configured to execute the program instructions to cause the computing system to receive information relating to whether the member is eligible for an incentive. In some embodiments, the one or more processors can be further configured to execute the program instructions to cause the computing system to determine and/or validate whether the member is eligible for an incentive.

In some embodiments, automatically calculating the incentive can include determining an incentive type and an incentive amount.

In some embodiments, the one or more processors can be further configured to execute the program instructions to cause the computing system to determine whether the incentive is an advance.

In some embodiments, the one or more processors can be further configured to execute the program instructions to cause the computing system to determine whether the member has already received the incentive or a portion thereof.

In some embodiments, the one or more processors can be further configured to execute the program instructions to cause the computing system to determine whether the incentive complies with internal or external regulations.

In some embodiments, the one or more data item properties can include an incentive type, an incentive constraint, an incentive amount, an incentive execution date, a member identification, a reviewer of a member, or an objective.

### BRIEF DESCRIPTION OF THE DRAWINGS

FIG. 1 is a block diagram illustrating an example incentive management system in communication with a user device and a storage device.

FIG. 2 illustrates an example interactive user interface for inputting data relating to a member of an organization.

FIG. 3 is a flowchart illustrating an example process for storing and retrieving data according to an optimized data schema.

FIG. 4 illustrates an example interactive user interface for reviewing member profile data.

FIG. 5 is a flowchart illustrating an example process for calculating an incentive.

FIG. 6 illustrates an example interactive user interface for reviewing information relating to a calculated incentive.

FIG. 7 illustrates an example interactive user interface for reviewing an audit log.

### DETAILED DESCRIPTION

### Overview

Embodiments of the present disclosure relate to an improved system for tracking, calculating, reviewing, and approving incentives of members associated with an organization, such as employees, contractors, or other entities. The system can receive data relating to a member during an onboarding process. The system can categorize the data according to a data schema which can be based on one or more attributes or properties of the data. The system can store the data in one or more data sets according to the categorization. Separating and storing the entered data according to the data schema allows for handling complex and nuanced conditions when processing the information (e.g., to calculate incentives, to generate notifications, etc.) and also results in faster processing times by improving data access and retrieval from the specific data sets of the data schema.

The system can automatically calculate incentives based on accessing relevant data in the data schema. A calculated incentive triggers any necessary reviews and approvals. An approval process can include predefined reviewers and/or reviewing actions. The system can automatically notify reviewers (e.g., via email) when they need to take a reviewing action (e.g., approving, rejecting, editing, and/or flagging the incentive). The system can store reviewing actions and related information in an audit log which can facilitate internal and/or external audit procedures as well as compliance validation.

### Terms

To facilitate an understanding of the systems and methods discussed herein, several terms are described below. These terms, as well as other terms used herein, should be construed to include the provided descriptions, the ordinary and customary meanings of the terms, and/or any other implied meaning for the respective terms, wherein such construction is consistent with context of the term. Thus, the descriptions below do not limit the meaning of these terms, but only provide example descriptions.

Incentive Management System (Also referred to as “the management system” or “the system”): A system to facilitate aggregating, storing, calculating, analyzing, and/or reviewing information relating to members to determine incentives of the members. A management system may be configured to calculate incentives of a member, coordinate review, approval, and/or execution of the incentives, and/or generate interactive graphical user interfaces to facilitate review of, and interaction with, the incentives.

Team Member (Also referred to as “member”): An individual member of an organization, for example, an employee of an organization.

Member Activities: The various functions or operations performed by a member.

Objective: A task or goal for a member to complete. An objective can be assigned to a member. Example objectives can include closing a deal, securing an upsell, and the like.

Incentive: A benefit that is provided from an organization to a member for having completed an objective or group of objectives. In some embodiments, an incentive includes cash, equity, stock, or any combination of the foregoing. In some embodiments, the incentive includes a one-time distribution to the member. In some embodiments, the incentive includes a series of distributions to the member.

Milestone: A portion of an incentive that is distributed to a member before other portions of the incentive are distributed to the member and/or before a final execution date of an incentive. In some embodiments, a milestone can be an advance on an incentive (e.g., the milestone amount is deducted from the incentive amount). In some embodiments, a milestone can be in addition to an incentive that is to be distributed at a later date.

Member Profile Data (Also referred to as “profile data”): Any data associated with a member, such as to define objectives that a member is expected to complete and/or objectives that are required for a member to complete to be eligible for an incentive. Profile data may define incentives and/or milestones of the member. Profile data may define timelines for distributing incentives to a member. Profile data may be automatically extracted from electronic documents (e.g., databases or OCR'd documents) and/or generated based on user input via a user interface. Profile data or portions thereof may be selected from a set of preconfigured or predefined profile data. For example, a user may select particular incentives and/or milestones, from among a set of predefined options, to be associated with a member as part of the member's profile data. Advantageously, providing pre-defined profile data options to be associated with a member may improve efficiency of the system and/or accuracy with which the system performs incentive-related tasks. Profile data may be electronically stored and accessible by the system. In some embodiments, member profile data can include and/or be used to generate an agreement between a member and an organization, such as an employment agreement, contract, or terms.

User: A single person or a group of users, such as, for example, organizations, groups, and business entities. In some embodiments, user refers to a computing device of a user rather than, or in addition to, an actual human operator of the computing device. A user may interact with the system via a user interface to review, edit, approve, reject, execute, and/or share incentives of members. In some embodiments, a member may be a user and/or take some or all of the same actions as a user.

Reviewer: A user that reviews, approves, rejects, and/or takes some other action regarding incentives of members. In some embodiments, a reviewer may be a user and/or take some or all of the same actions as a user.

Audit Log: A log for tracking information relating to member data, such as incentives. The system can generate, store, and update an audit log. A user can interact with the audit log via a user interface rendered by the system to edit data in the audit log, review actions taken by other users, review details of an incentive such as a status of the incentive including whether the incentive has been approved and/or executed, and the like.

### Example System Overview

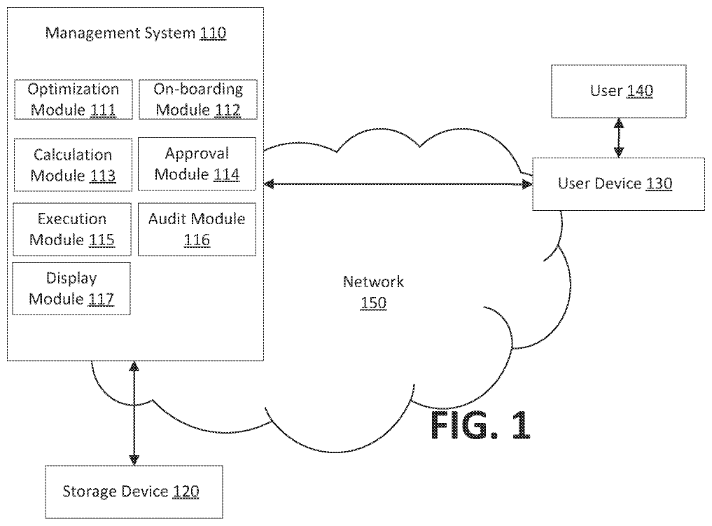

FIG. 1 is a block diagram illustrating an example management system 110 in communication with a user device 130 and a storage device 120. In this example, the management system 110 includes an optimization module 111, an on-boarding module 112, a calculation module 113, an approval module 114, an execution module 115, an audit module 116, and a display module 117. In other embodiments, the management system 110 may include fewer or additional modules and/or functions associated with certain modules may be performed by other components. In some implementations, some or all of the modules 111, 112, 113, 114, 115, 116, 117 may be located in the storage device 120, in another device in communication via the network 150 and/or at the user device 130.

In some embodiments, some or all of the modules 111, 112, 113, 114, 115, 116, 117 include executable software instructions configured, when executed, to perform one or more operations or functions of the modules 111, 112, 113, 114, 115, 116, 117. In some embodiments, the management system 110 can include a processor configured to execute software instructions such as the software instructions of the modules 111, 112, 113, 114, 115, 116, 117 to perform the operations of the management system 110, as described herein.

As shown, the user device 130 is in communication with the management system 110 via a network 150, which may include any combination of networks, such as a LAN, WAN, and/or the Internet. The user device 130 may interact with the management system 110 to execute the various modules of the management system 110 (e.g., the modules 111, 112, 113, 114, 115, 116, 117) to perform one or more functions or operations of the management system 110 as described in greater detail herein. As shown, a user 140 interacts with the user device 130. The user 140 can interact with the management system 110 via the user device 130 such as to view one or more user interfaces generated by the management system 110 and/or to cause the management system 110 to perform one or more functions or operations. In some embodiments, the user 140 may be a reviewer.

In the example of FIG. 1, the management system 110 is in communication with a storage device 120 via network 150. In other embodiments, the storage device 120 is part of the management system 110. The storage device 120 can include any computer readable storage medium and/or device (or collection of data storage mediums and/or devices), including, but not limited to, one or more memory devices that store data, including without limitation, dynamic and/or static random access memory (RAM), programmable read-only memory (PROM), erasable programmable read-only memory (EPROM), electrically erasable programmable read-only memory (EEPROM), optical disks (e.g., CD-ROM, DVD-ROM, etc.), magnetic disks (e.g., hard disks, floppy disks, etc.), memory circuits (e.g., solid state drives, random-access memory (RAM), etc.), and/or the like. As another example, the storage device 120 can also include a hosted storage environment that includes a collection of physical data storage devices that may be remotely accessible and may be rapidly provisioned as needed (commonly referred to as “cloud” storage). Data stored in the storage device 120 can include, for example, member profile data, member objective data, member activity data, incentive data, audit log data, and the like.

In general, the optimization module 111 is configured to categorize and aggregate data relating to a member such as member profile data. The optimization module 111 may categorize data according to one or more criteria. The optimization module 111 can store data in one or more data sets according to a categorization of the data. This may advantageously reduce processing times and improve efficiency of the system, for example, by reducing a number of data sets the system must access when retrieving data, such as to determine an incentive.

In general, the on-boarding module 112 is configured to facilitate receiving, organizing, analyzing, and storing member profile data. The on-boarding module 112 receives data inputted into the system such as manually entered by a user via a user interface and/or retrieved from an existing data source with member profile data, such as a customer relationship management (CRM) system. The on-boarding module 112 can analyze the inputted data to create member profile data. In some embodiments, the on-boarding module can create an agreement, such as a term sheet, between a member and an organization, based on the inputted data. The on-boarding module 112 can store the member profile data and/or agreement data. The on-boarding module 112 can coordinate review of generated member profile data. For example, the on-boarding module 112 can generate notifications to appropriate reviewers to review and approve the generated and/or entered member profile data.

In general, the calculation module 113 is configured to calculate incentives. The calculation module 113 can determine whether a member has performed the necessary objectives to merit an incentive. The calculation module 113 can determine the incentive appropriate for the objectives completed by a member. The calculation module 113 can calculate an incentive amount and incentive execution date. The calculation module 113 can determine incentive calculations, based on information from a variety of sources, including, for example, member profile data, and member activities. The calculation module 113 can retrieve information from a variety of sources including data stored within the system and data retrieved from devices or systems external to the system.

In general, the approval module 114 is configured to coordinate review and approval of incentives. The approval module 114 can determine whether an incentive needs to be approved (e.g., prior to execution). The approval module 114 can generate incentive approval requirements. Incentive approval requirements can include one or more actions that need to take place before an incentive is executed. For example, incentive approval requirements may include a number of reviewers that need to approve an incentive, a type of reviewer (e.g., level of authority) that needs to approve an incentive, and the like. The approval module 114 can determine the reviewer(s) that are required to approve an incentive. In some embodiments, reviewers may be determined based at least in part on a division, group, and/or team of the organization. In some embodiments, the approval module 114 may restrict access to incentives to only certain reviewers determined by the approval module 114 to be approved to access and review the incentive. The approval module 114 can generate notifications (e.g., emails, messages, etc.) to any reviewers required or desired to review and/or approve an incentive.

In general, the execution module 115 is configured to coordinate execution (e.g., payment) of incentives. The execution module 115 can determine whether an incentive has been reviewed and/or approved. The execution module 115 can determine a date before which an incentive must be executed. The execution module 115 can be configured to execute the incentive, including exporting data relating to an incentive to an external system and/or initiating transfer of an approved incentive amount to an account of the member.

In general, the audit module 116 is configured to store and track information relating to incentives, such as in an audit log. The audit module 116 can receive and store information from reviewers, such as review notes or feedback relating to an incentive. The audit module 116 can store actions taken by reviewers, such as whether a reviewer has reviewed, approved, and/or rejected an incentive. The audit module 116 can track a status of an incentive, such as whether the incentive is pending review, has been reviewed and/or approved, and/or has been executed. The audit module 116 can facilitate coordinating and evaluating incentive compliance with regulations that are internal to an organization and/or regulations that are external to an organization such as governmental regulations.

In general, the display module 117 is configured to generate data for rendering interactive graphical user interfaces for display on the user device 130. As discussed further below, the user interfaces are advantageously interacted with by the user 140 to enter, manipulate, analyze, and/or review data associated with members (e.g., member profile data and/or incentives).

### Example System Implementations

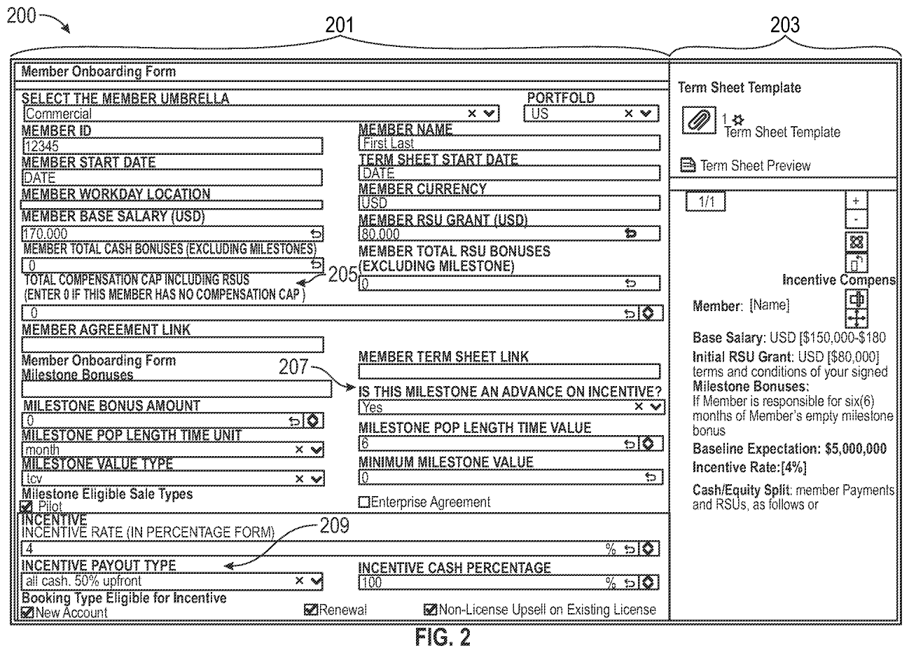

FIG. 2 illustrates an example onboarding interactive user interface 200 generated by the management system and displayed by a user device in communication with the system. The user interface 200 can be viewed and/or interacted with by a user to facilitate generating member profile data.

The user interface 200 includes a data input portion 201 and a data review portion 203. As shown, the data review portion 203 is displayed simultaneous with the data input portion 201. The data review portion 203 is adjacent to the data input portion 201 within the user interface 200. In some embodiments, the user interface 200 may include only the data input portion 201 or only the data review portion 203. A user may toggle between the data input portion 201 and the data review portion 203. In some embodiments, a user may change the size of the data input portion 203 and/or the data review portion 201 such as by clicking and dragging to enlarge or shrink either of portions 201 or 203.

In some embodiments, the data review portion 203 displays information that is entered into the data input portion 201 in real-time (e.g., the data is populated in the data review portion 203 at a time shortly after it is entered into the data review portion 201 so as to be negligible and/or imperceptible to human senses). In some embodiments, the data review portion 203 displays information that is entered into the data input portion 201 periodically and/or automatically such as every minute. In some embodiments, the data review portion 203 displays information that is entered into the data input portion 201 in response to a user selection such as to update or refresh the data review portion 203. Advantageously, a user may enter information into the data input portion 201 and simultaneously view a corresponding and resulting update to the data review portion 203.

In this example, the data review portion 203 displays a view of member profile data in the form of an agreement or contract term sheet between a member and an organization. The member profile data is based on the data received via the data input portion 201. Advantageously, by displaying the data input portion 201 and the data review portion 203 (e.g., simultaneously and adjacent), the user interface 200 facilitates generating member profile data to be stored in the system.

In this example, the data input portion 201 includes numerous data entry fields. A user can navigate between the data entry fields to enter information associated with the respective fields. For example, as shown, the data input portion 201 includes fields for member ID, member name, member start date, etc. The data input portion 201 also include fields related to member compensation (e.g., base, max), milestones, incentives (rates, amounts, types, dates), objectives, regulations (internal or external), and the like.

Data entry field 205 is configured to receive information relating to a total compensation cap. This may be a maximum compensation (e.g., incentive plus base pay) that a member can receive. A user may enter an amount into data entry field 205 based on internal and/or external regulations. For example, an organization may have rules regarding a maximum compensation a member within a certain role or experience level can receive and/or a government can have laws regarding a maximum compensation certain members can receive. Advantageously, by receiving (e.g., via data entry field 205), storing, and using information relating to internal and/or external regulations, the system can facilitate compliance with such regulations, such as when determining incentives.

Data entry field 207 is configured to receive information relating to whether a milestone is an advance on an incentive. Advantageously, the system can use this information to determine whether an incentive amount needs to be adjusted (e.g., milestone amount deducted therefrom) such as when determining incentives. This may prevent a member from being compensated twice for having completed the same objective.

Data entry field 209 is configured to receive information relating to an incentive type. Via data entry field 209, a user can select the type of incentive, such as cash, equity, stock, and the like. In some embodiments, various portions of an incentive may be different incentive types (e.g., cash, equity, stock). In this example, a user has selected that an incentive is all cash. As another example, a user may select that an incentive is 50% cash and 50% stock, with half of the 50% stock to vest immediately and half of the 50% stock to vest after a certain time frame. Via data entry field 209, a user can also select how the incentive is to be executed, such as when the incentive (or portions thereof are to be distributed to a member). In this example, a user has selected that 50% of the incentive is to be distributed to the member upfront. In some embodiments, various portions of an incentive can be distributed over a series of dates.

In some embodiments, one or more of the fields of data input portion 201 can auto populate based on information stored in and/or accessed by the system. In some embodiments, the data input portion 201 can include more or fewer data entry fields than those shown in the example of FIG. 2. In some embodiments, the data input portion 201 can include data entry fields relating to different information than those shown in the example of FIG. 2.

Based on the data entered into the data input portion 201, the system can generate member profile data. The generated member profile data can be stored in the system and may be used to calculate incentives of the member.

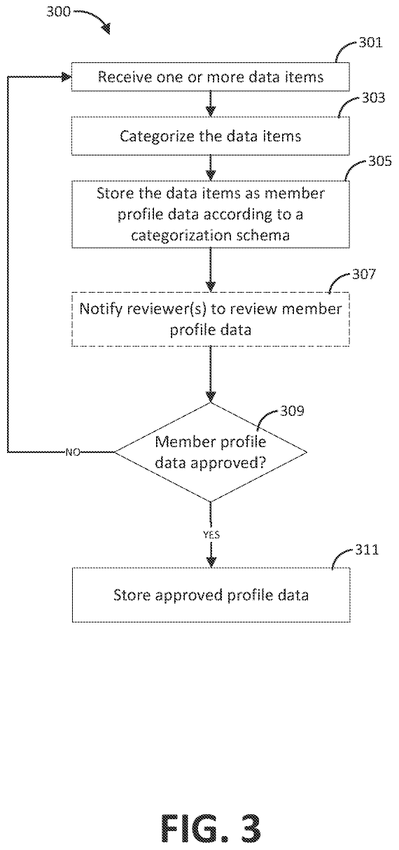

FIG. 3 is a flowchart illustrating an example process 300 for storing and retrieving data according to an optimized data schema. The process 300, or portions thereof, can be performed by the system, such as by the optimization module 111 of the management system described with reference to FIG. 1. Depending on the embodiment, the process 300 may include fewer or additional blocks and the blocks may be performed in an order that is different than illustrated.

At block 301, the system receives one or more data items. The data items can be manually entered into the system via a user interface such as shown and described with reference to FIG. 2 and/or accessed from an internal or external data source.

At block 303, the system categorizes the received data items according to an optimization or categorization schema. The data items can be categorized based on one or more criteria such as a data item type. For example, the system can categorize data items according to one or more properties associated with the data items including, for example, incentive type, incentive constraint (e.g., cannot execute incentive until invoice received from third party associated with member objective, incentive void if third party cancels contract associated with member objective, etc.), incentive amount, incentive execution dates, member identification, reviewers of a member, objectives, incentives for which a member is eligible, and the like. In some embodiments, the optimization or categorization schema can be based on the member profile data, or portions thereof, associated with a member with whom the data items are associated. In some embodiments, the member profile data or portions thereof may include selected (e.g., during an onboarding process) from among a plurality of pre-defined or preconfigured profile data such as incentive types, milestones, when to execute incentives, or the like. The member profile data may define the optimization or categorization schema (e.g., how/where to store data items in datasets) such that the data items associated with a member are stored in the data sets as pre-defined by member profile data assigned to the member (e.g., during an onboarding process).

At block 305, the system can store the data items in a plurality of data sets according to the categorization. In some embodiments, the data sets are independently accessible so that information regarding a particular type of member profile data may be accessed quicker from a particular data set that includes the desired information, rather than a larger data set that includes all of the data items for the member. For example, the system can store data items that relate to incentives for which a member is eligible in a first data set and can store data items that relate to incentive execution dates in a second data set, and so forth. The categorization may be referred to herein as a categorization schema. As discussed above, the categorization schema can be based at least in part on member profile data associated with the member.

Advantageously, storing data according to a categorization schema can improve the efficiency and/or processing times of the system. As one example, a categorization schema can improve system performance by reducing the number of data sets that the system must access, such as when determining incentives, because the system need only access those data sets that include data that is relevant (e.g., based on the categorization) to a particular determination or calculation. Thus, the system can avoid accessing unnecessary and/or redundant information when performing incentive-related calculations and/or determinations (e.g., according to member profile data) and instead may only access the information that is necessary to perform a particular incentive-related determination (e.g., according to member profile data) associated with a member. As another example, a categorization schema can improve system performance by reducing the amount of data that must be parsed and/or traversed. For example, the system may need to only parse data from a single data set (pertaining to objectives) that includes only a portion of all data of member profile data to determine the objectives that must be satisfied for a member to be eligible for an incentive, for example, rather than parse all member profile data.

Advantageously, a categorization schema can allow the system to determine complex incentives. For example, the categorization schema may include data sets configured to store nuanced data that pertains to a particular situation, incentive, or member. As one example, a categorization schema may include a data set that includes data relating to a currency exchange rate between countries. As another example, a categorization schema may include a data set that includes data relating to conditions under which a member may lose an incentive. The degree to which data is categorized within a schema (e.g., more data sets and more specific categories of data sets) may correlate to the complexity of incentives the system is able to calculate. By including more data sets and more specific data sets within a schema, the system can account for a wider variety of scenarios (e.g., highly nuanced member profile data) when calculating incentives.

Advantageously, a categorization schema can improve an accuracy with which the system performs incentive-related tasks (e.g., calculating incentives). For example, the system may more accurately and more efficiently perform operations (e.g., to determine incentives), where the operations are dictated by the member profile data, and the data items used in the operations have been stored (for retrieval and processing) according to a categorization schema which may also be dictated by the member profile data.

In some embodiments, a user can define the categories to be included within a categorization schema. In some embodiments, a user may add and/or remove categories from a categorization schema.

At block 307, the system may optionally notify one or more reviewers to review the member profile data. In some embodiments, the reviewer(s) can approve or reject member profile data. In some embodiments, the reviewer(s) can leave comments or notes relating to the member profile data, such as suggested edits to the member profile data.

At block 309, the system determines whether member profile data has been approved. In some embodiments, the system determines whether an entire member profile data (e.g., pertaining to a single member) has been approved. In some embodiments, the system determines whether portions of the member profile data have been approved. The system can determine that the member profile data has not been approved if it has not yet been reviewed by all necessary reviewers, it has been rejected by a reviewer, and/or if a reviewer has left comments or suggested edits. The system can determine that member profile data has been approved if all necessary reviewers have reviewed the profile data and/or approved the profile data.

In response to determining that the member profile data (or portions thereof) has not been approved, the process can return to block 301 where the system receives additional and/or updates data items such as via manual input via a user interface. In response to determining that the member profile data (or portions thereof) has been approved, the system, at block 311 may store the member profile data as approved (e.g., not discard or update the profile data).

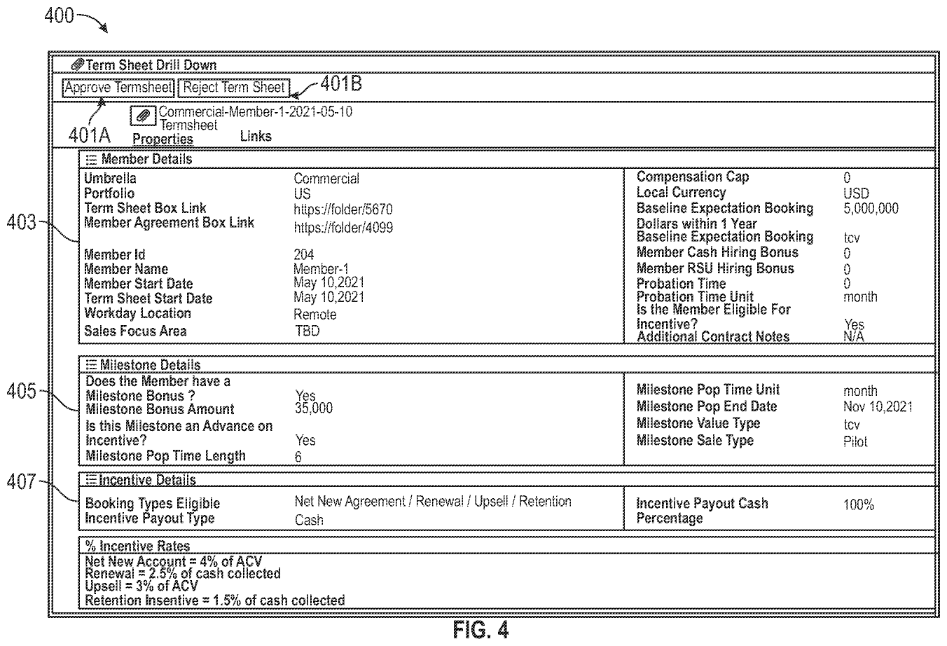

FIG. 4 illustrates an example interactive user interface 400 generated by the management system and displayed by a user device in communication with the system. The user interface 400 can be viewed and/or interacted with by a user to facilitate generating member profile data.

The user interface 400 includes selectors 401A, 401B, a member details portion 403, a milestone details portion 405, and an incentive details portion 407. The user interface 400 displays information relating to (e.g., the details of) the member profile data. A user may view the user interface and various portions thereof (e.g., 403, 405, 407) to determine whether to approve or reject the member profile data. A user can select approve selector 401A or reject selector 401B to approve or reject, respectively, the member profile data. In response to selection of selector 401A or 401B, the user interface may display an input field wherein a reviewer can enter notes, comments, feedback, and the like, and why the reviewer approved or rejected the member profile data.

The member details portion 403 displays member profile data that relates to the member with which the data is associated. In the example of FIG. 4, the member details portion 403 includes information such as a member name, a member ID, member start date, and the like. The member details portion 403 also includes a link to additional member profile data and an agreement between the member and the organization. The member details portion 403 also includes information relating to the objectives the member is expected to perform.

The milestone details portion 405 displays information relating to milestones associated with the member. In this example, the milestone details portion 405 shows whether the member has a milestone, the milestone amount, whether the milestone is an advance on an incentive, and the like.

The incentive details portion 407 displays information relating to incentives associated with the member. In this example, the incentive details portion 407 shows the types of objectives that merit an incentive, the type of incentive, incentive rates, and the like.

In some embodiments, the system can display a user interface that displays a list of all members that require review and approval of their respective member profile data. In response to user selection of a member displayed in the list, the user interface may display member profile data pertaining to that member. A user, such as a reviewer, can view and interact with the list of members requiring approval to review the member profile data of members in an efficient manner.

In some embodiments, the system can display a user interface that displays a list of all members whose member profile data has been rejected, not approved, and/or requires further review. The list may also display a reviewer who rejected the profile data. The list may also display notes, such as may have been entered by a reviewer, relating to the review performed by the reviewer, such as reasons why the member profile data was rejected and/or suggested changes to be made to the member profile data. In response to user selection of a member displayed in the list, the user interface may display member profile data pertaining to that member to facilitate further review and/or may navigate the user to a user interface (e.g., interface 200 of FIG. 2) for editing or updating the member profile data.

In some embodiments, the system can display a user interface that displays a list of all members whose member profile data has been approved. The list may also display other information relating to the review such as a reviewer who approved the profile data, a date and time of approval, and the like. In response to user selection of a member displayed in the list, the user interface may display member profile data pertaining to that member.

In some embodiments, the system can display a user interface that displays a list of all members with an inactive status such as those who have left the organization. In some embodiments, the system may receive an indication of a status of members (e.g., active, inactive, etc), such from an external data source, member profile data, and/or other data within the system. In some embodiments, the system may automatically determine members who are not active and remove them from incentive calculation processes such as to avoid distributing incentives to them.

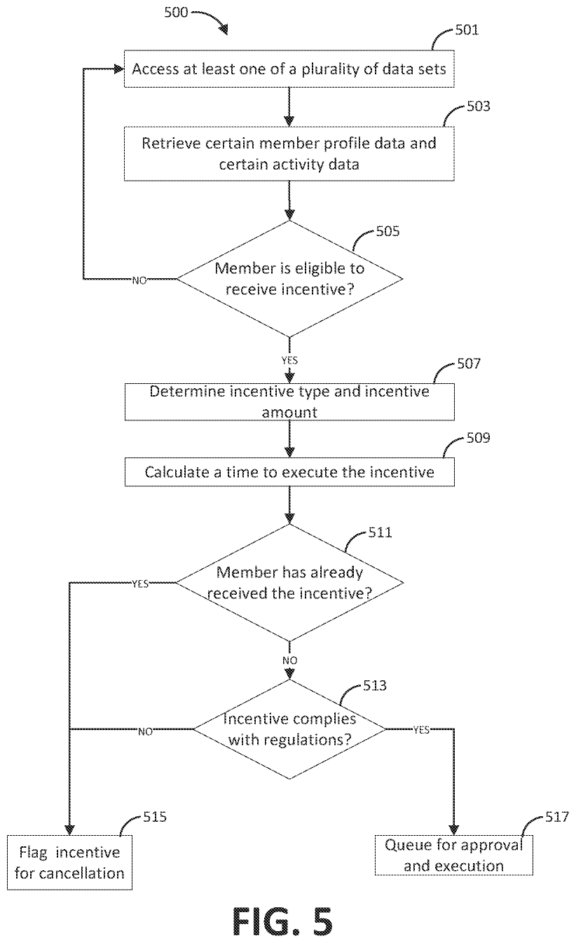

FIG. 5 is a flowchart illustrating an example process 500 for calculating an incentive. The process 500, or portions thereof, can be performed by the system, such as by the optimization module 113 of the management system described with reference to FIG. 1. Depending on the embodiment, the process 500 may include fewer or additional blocks and the blocks may be performed in an order that is different than illustrated.

In some embodiments, the process 500, or portions thereof, can be executed periodically such as hourly, daily, or weekly. In some embodiments, the process 500, or portions thereof, can be executed in response to a user request. In some embodiments, the process 500, or portions thereof, can be automatically executed in response to occurrence of a particular member activity, completion of an objective, and/or the like.

At block 501, they system accesses at least one of a plurality of data sets. The data sets can be stored in the system and/or be stored external to the system such as on an external device or system. The data sets can include data that has been categorized according to a categorization schema such as described with reference to FIG. 3. The system may access only certain data sets (e.g., according to a categorization schema) based on the information needed to perform a certain calculation which may improve efficiency, reduce processing times, improve accuracy of the calculation, and/or improve ability to perform audit-related functions. For example, to calculate an incentive amount, the system may access a data set categorized as storing data relating to incentive amounts and may not access a data set categorized as storing data relating to a member start date because that may not be relevant for the particular calculation.

At block 503, the system retrieves data necessary to perform the calculation. In this example, the system retrieves member profile data and activity data. The system may not retrieve an entirety of member profile data associated with a particular member. Rather the system may retrieve only the data of the member profile data (e.g., based on categorized data sets) that is relevant to the particular calculation, which may improve system processing times, increase calculation accuracy, reduce the likelihood of performing erroneous and/or unnecessary operations, and/or facilitate auditing. Similarly, the system may only retrieve certain activity data that is relevant rather than an entirety of activity data associated with a member.

In some embodiments, the system may retrieve additional data at block 503 on which the particular calculation may depend. For example, the system may retrieve information relating to customer invoices paid to the organization and on which the calculation of the incentive depends.

At block 505, the system determines whether the member is eligible to receive an incentive. The determination may be based, at least in part, on member profile data and activity data. For example, a member may be eligible to receive an incentive if the member has completed all objectives pertaining to that incentive. As another example, a member may be eligible to receive an incentive if they have satisfied other conditions, including for example, if they have been a member of the organization for a certain period of time, if they have completed a threshold level of objectives, and the like. As another example, a member may be eligible to receive an incentive if a customer has paid an invoice to the organization relating to the member and/or incentive. If the system determines that the member is eligible to receive an incentive, the system continues to block 507, and if not, then the system returns to block 501. In some embodiments, the system may receive information relating to whether a member is eligible to receive an incentive in addition to or instead of making such a determination. For example, a user may input to the system the status of the member's eligibility for an incentive.

At block 507, the system determines the incentive type and the incentive amount. In some embodiments, determining the incentive type can include determining whether the incentive is a milestone and whether the milestone is an advance on an incentive. In some embodiments, determining the incentive type can include determining other characteristics of the incentive such as whether the incentive is cash, stock, equity, or the like. The determination at block 507 may be based, at least in part, on member profile data and activity data.

At block 509, the system determines a time to execute the incentive. In some embodiments, determining a time to execute an incentive can include determining a date and/or a time of day to execute the incentive. In some embodiments, determining a time to execute the incentive can include determining whether the incentive is a one-time distribution or is to be executed over a series of distributions. The determination at block 509 may be based, at least in part, on member profile data and activity data. Advantageously, determining a time (e.g., date and/or time of day) to execute an incentive can facilitate ensuring that the incentive complies with internal regulations, external regulations, and/or with an agreement between the member and the organization.

At block 511, the system determines whether the member has already received the calculated incentive and/or whether the incentive has already been queued for execution/processing. For example, a member may have already received, in whole or in part, an incentive such as through milestones and/or other advances on the incentive. Advantageously, determining and tracking the incentive type, such as at block 507, may facilitate determining whether a member has already received an incentive to prevent giving duplicate incentives to the member. The determination at block 511 may be based, at least in part on member profile data and/or data relating to incentives already provided to the member. If the system determines that the member has already received a calculated incentive or portion thereof (e.g., for a particular objective or milestone) and/or that the calculated incentive has already been queued for execution (e.g., by an external or internal payroll system), the system may proceed to block 515 to flag the calculated incentive as already paid (or for cancellation), and otherwise proceeds to block 513.

At block 513, the system determines whether the calculated incentive complies with regulations. The regulations can include internal regulations such as organization policies, rules, and the like. For example, an internal regulation may be a prohibition on providing a certain number or amount of benefits to a member within a given time frame. The regulations can include external regulations such as government laws, ordinances, codes, and the like. In some embodiments, determining whether the calculated incentive complies with regulations can include determining whether the incentive adheres to member profile data and/or an agreement between the member and the organization. Advantageously, determining whether the incentive complies with regulations can facilitate adhering to internal and external standards such as laws as well as verifying such adherence. If the system determines that the incentive does not comply with regulations, the system may proceed to block 515 to flag the calculated incentive for cancellation, and otherwise proceeds to block 517.

At block 517, the system queues the calculated incentive for approval and/or execution. In some embodiments, an incentive calculated by the system must be reviewed and approved prior to execution. Advantageously, requiring review and/or approval prior to execution may improve an accuracy with which incentives are distributed. Advantageously, calculating incentives and queuing them for review, approval and execution facilitates distribution of accurate incentives to members in an efficient manner.

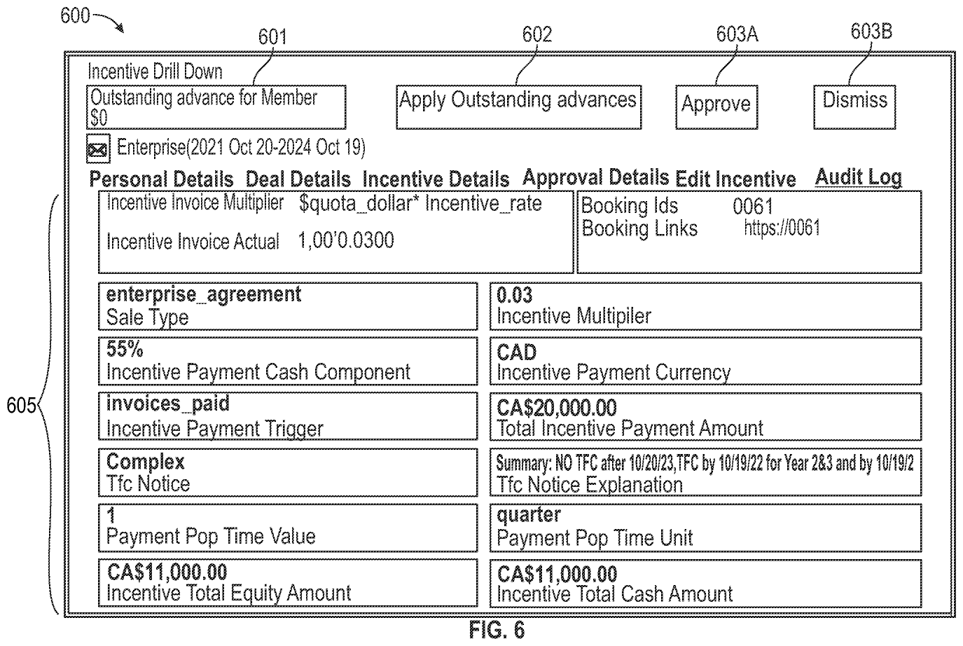

FIG. 6 illustrates an example interactive user interface 600 generated by the management system and displayed by a user device in communication with the system. The user interface 600 can be viewed and/or interacted with by a user to facilitate reviewing and/or approving incentives that have been calculated by the system.

The user interface 600 includes an advances indicator 601, an advance selector 602, a review selector 603 (e.g., approve selector 603A and dismiss selector 603B), and an incentive details portion 605.

The advances indicator 601 shows a total amount of advances that are outstanding for the member. The advances can include milestones or other incentives that have already been distributed to the member. A user can select advance selector 602 to apply the outstanding advances shown in indicator 601. Selecting the advance selector 602 may cause the incentive details portion 605 to update (e.g., to show incentives to be distributed to the member after having accounted for the outstanding advances). Advantageously, the advances indicator 601 and advance selector 602 may facilitate preventing distributing duplicate or redundant incentives to a member.

The incentive details portion 605 displays information relating to one or more incentives that have been calculated by the system and are pending review and approval for execution and distribution to the member. The incentive details portion 605 includes incentive details such as an objective completed by the member relating to the incentive, an incentive type and/or amount, whether customers have paid invoices relating to the incentive, a total value of the incentive (e.g., accounting for advances and possible future distributions), a formula for computing the incentive, a time for executing or distributing the incentive, and the like.

In some embodiments, a user may be able to select via the interface 600 to view details regarding objectives completed by the member that pertain to the incentive.

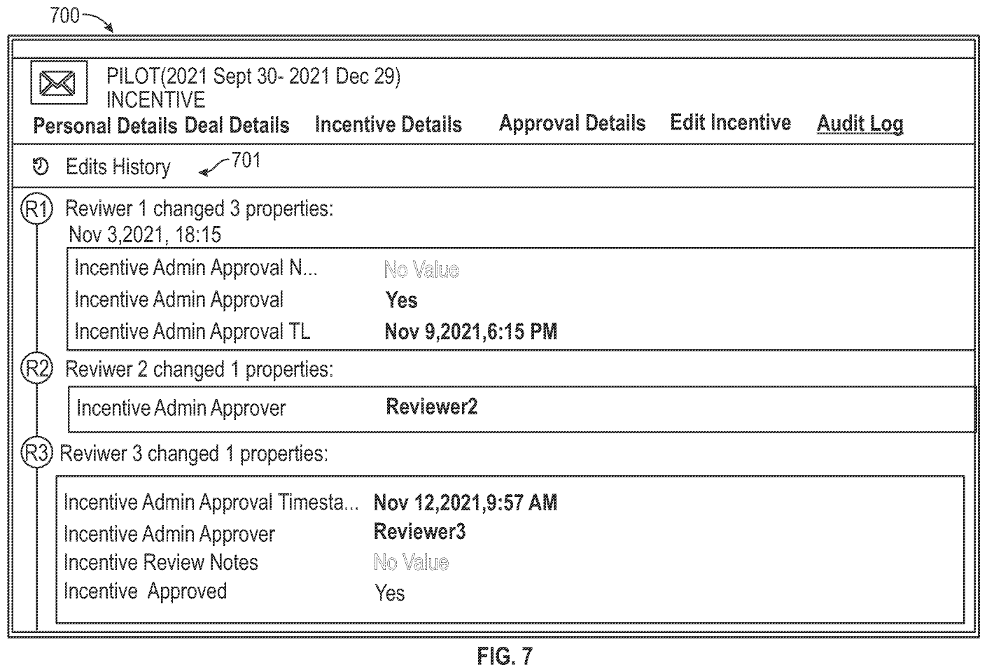

In some embodiments, a user may be able to select via the interface 600 to edit the incentive. For example, in response to a user selection, the interface 600 may display a variety of data entry fields relating to various aspects of the incentive into which a user may enter information to update or edit the incentive. For example, a user may be able to enter via a data entry field a new total incentive amount if the user does not approve of a total incentive amount shown in the incentive details portion 605. Any edits made to a commission, such as by a reviewer, may be stored in an audit log, for example, as shown and described with reference to FIG. 7.

In some embodiments, the system can display a user interface that displays a list of all incentives that require review and approval prior to their execution. In response to a user selection of an incentive displayed in the list, the user interface may display additional data pertaining to that incentive. A user, such as a reviewer, can view and interact with the list of incentives requiring approval to review the calculated incentives prior to their execution in an efficient manner.

In some embodiments, the system can display a user interface that displays a list of all incentives that have been rejected, not approved, and/or requires further review. The list may also display a reviewer who rejected the incentive. The list may also display notes, such as may have been entered by a reviewer, relating to the review performed by the reviewer, such as reasons why the incentive was rejected and/or suggested changes to be made to the incentive. In response to user selection of an incentive displayed in the list, the user interface may display additional details pertaining to that incentive to facilitate further review.

In some embodiments, the system can display a user interface that displays a list of all incentives that have been approved. The list may also display other information relating to the review such as a reviewer who approved the incentive, a date and time of approval, and the like. In response to user selection of an incentive displayed in the list, the user interface may display additional details pertaining to that incentive.

FIG. 7 illustrates an example interactive user interface 700 generated by the management system and displayed by a user device in communication with the system. The user interface 700 can be viewed and/or interacted with by a user to facilitate reviewing an audit log.

The user interface 700 includes an edits history portion 701. The edits history portion 701 displays information relating to a history of edits including revisions, actions, and/or updates that have been made to an incentive. In this example, the edits history portion 701 shows that reviewer 1 changed 3 properties of the incentive, including that reviewer 1 approved the incentive and a date and time associated with the approval. As another example, the edit history portion can show who changed an incentive amount, when, why, and by how much.

Via the user interface 700, a user may quickly review how an incentive has been edited, who has edited an incentive, the dates and times of the edits, notes associated with the edits, and the like. Advantageously, the user interface 700 may facilitate ensuring an incentive complies with internal and/or external regulations.

### Additional Implementation Details and Embodiments

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, declarative programming languages, such as SQL, and procedural programming languages, such as the “C” programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. Each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

Each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. However, no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. An incentive management computing system comprising:
a computer readable storage medium having program instructions embodied therewith; and
one or more processors configured to execute the program instructions to cause the computing system to:
receive one or more data items associated with a member of an organization;
categorize said one or more data items according to a categorization schema based at least on one or more data item properties associated with the data items;
store the one or more data items in at least one of a plurality of data sets, wherein each data set of the plurality of data sets corresponds to one or more data item type and wherein the one or more data items are stored according to the categorization schema;
generate, based on the received one or more data items, member profile data;
store the member profile data in one of the plurality of data sets;
access at least one of the plurality of data sets to retrieve the member profile data and at least one of the one or more data items;
automatically calculate an incentive based at least in part on the member profile data and the retrieved one or more data items;
in response to calculating the incentive, generate a review process indicating one or more reviewers;
provide user interface information to each of the one or more reviewers, wherein the user interface information is configured to display an interactive user interface indicating the calculated incentive and includes options for selection of a reviewing action of a plurality of predefined reviewing actions;
receive, from each of the one or more reviewers, an indication of a selected reviewing action;
in response to determining that the selected reviewing action meets an incentive approval requirement, generate execution data for executing the incentive; and
initiate execution of the incentive according to the execution data.

2. The computing system of claim 1, wherein the one or more processors are further configured to execute the program instructions to cause the computing system to:
access, according to the categorization schema, less than all of the plurality of data sets to retrieve the member profile data and at least one of the one or more data items.

3. The computing system of claim 1, wherein the one or more processors are further configured to execute the program instructions to cause the computing system to:
retrieve activity data relating to actions performed by the member; and
automatically calculate the incentive based at least in part on the activity data.

4. The computing system of claim 1, wherein the member profile data includes objectives assigned to the member to be completed by the member.

5. The computing system of claim 4, wherein the calculated incentive includes a date for executing the incentive.

6. The computing system of claim 1, wherein the one or more processors are further configured to execute the program instructions to cause the computing system to:
in response to generating the member profile data, generate a request to send to the one or more reviewers to approve the member profile data.

7. The computing system of claim 1, wherein the member profile data includes an agreement between the member and the organization.

8. The computing system of claim 1, wherein the one or more processors are further configured to execute the program instructions to cause the computing system to:
in response to generating the review process, generate a notification to notify the one or more reviewers to review the calculated incentive.

9. The computing system of claim 1, wherein the plurality of predefined reviewing actions includes one or more of approving the incentive, rejecting the incentive, or flagging the incentive.

10. The computing system of claim 1, wherein the one or more processors are further configured to execute the program instructions to cause the computing system to:
in response to receiving the selected reviewing action from each of the one or more reviewers, store the selected reviewing action in an audit log.

11. The computing system of claim 1, wherein the one or more processors are further configured to execute the program instructions to cause the computing system to:
receive from a reviewer of the one or more reviewers an indication of a selected update to the incentive;
in response to receiving the selected update to the incentive, update the incentive according to the selected update; and
store the selected update in an audit log.

12. The computing system of claim 1, wherein the one or more processors are further configured to execute the program instructions to cause the computing system to:
determine whether the member is eligible for an incentive.

13. The computing system of claim 1, wherein automatically calculating the incentive includes determining an incentive type and an incentive amount.

14. The computing system of claim 1, wherein the one or more processors are further configured to execute the program instructions to cause the computing system to:
determine whether the incentive is an advance.

15. The computing system of claim 1, wherein the one or more processors are further configured to execute the program instructions to cause the computing system to:
determine whether the member has already received the incentive or a portion thereof.

16. The computing system of claim 1, wherein the one or more processors are further configured to execute the program instructions to cause the computing system to:
determine whether the incentive complies with internal or external regulations.

17. The computing system of claim 1, wherein the one or more data item properties includes an incentive type, an incentive constraint, an incentive amount, an incentive execution date, a member identification, a reviewer of a member, or an objective.
